(19) United States
(12) Patent Application Publication
(10) Pub. No.: US 2017/0155695 A1
(43) Pub. Date: Jun. 1, 2017

(54) METHOD, DEVICE AND SYSTEM FOR UPLOADING LIVE VIDEO

(71) Applicants: Le Holdings (Beijing) Co., Ltd., Beijing (CN); LeCloud Computing Co., Ltd., Beijing (CN)

(72) Inventor: Lizhi WEI, Beijing (CN)

(21) Appl. No.: 15/245,275

(22) Filed: Aug. 24, 2016

Related U.S. Application Data
(63) Continuation of application No. PCT/CN2016/082824, filed on May 20, 2016.

(30) Foreign Application Priority Data
Nov. 26, 2015 (CN) 201510845632.2

(51) Int. Cl. H04L 29/06

(52) U.S. Cl. CPC H04L 65/4069; H04L 65/1069; H04L 67/42; H04L 67/1097

(57) ABSTRACT

Disclosed are a method, a device and a system for uploading live video. The method includes: receiving, by an edge server, a live video uploading request from a client, wherein the edge server is a node server in a CND system which provides data transmission service to the client; sending the uploading request to a control center, so that the control center configures uploading path information according to the uploading request; receiving, from the control center, the uploading path information, indicating a data transmission path and calculated in real time by the control center according to a preset uploading path configuration policy; and uploading live video data of the client to a live broadcasting platform according to the uploading path information.

### CROSS-REFERENCE TO RELATED APPLICATIONS

This application is a continuation of International Application No. PCT/CN2016/082824, filed on May 20, 2016, which is based upon and claims priority to Chinese Patent Application No. 201510845632.2, filed on Nov. 26, 2015, the entire contents of which are incorporated herein by reference.

### TECHNICAL FIELD

The present disclosure generally relates to the information technical field, and more particularly to a method, a device and a system for uploading live video.

### BACKGROUND

By adding a new network architecture layer into existing Internet, Content Delivery Networks (CDN) can deliver contents of a website to a network “edge” which is closest to users, so that users can obtain desired contents via a nearby network. Such technology can reduce network congestion of Internet and increase response speed when users access websites. The CDN network architecture mainly includes two parts, i.e., a center part and an edge part. The center part refers to a CDN network management center and a DNS redirection and parsing center, and is responsible for overall load balancing. The device system of center part is mounted in the network management center machine. The edge part, which is carrier for delivering in CDN, mainly refers to allopatric nodes, and is generally made up of caches, load balancers, and the like.

Live video broadcast refers to broadcasting live videos via Internet and streaming media technologies. With integration of rich elements such as images, texts, and sounds, and capability of providing good communication effects (such as sounds or facial expressions), live video broadcast has become a mainstream expression way in Internet field. By transmitting data in a real and vivid way, video can create a strong sense of presence and attract attentions, and thus present an impressive and memorable dissemination effect. At present, when uploading a live video via CDN networks, the edge sever will process the request which was initiated by a requesting user, and then receive the video from the requesting user and upload the video to a video platform via a certain uploading path, consequently other users can view the live video online. Live video broadcast requires a high real time performance, which means that the uploading path needs to have a good transmission performance. In prior live video uploading technologies, the uploading path which is preset is determined by the edge server. The uploading path is single and fixed, and thus if a certain node in the fixed path has a failure, manual amendments for the uploading path information in the edge server are needed in order to bypass the failed node. Obviously, such method is not applicable for uploading live video which requires high real time performance.

### SUMMARY

The present disclosure provides a method, a device and a system for uploading live video which are capable of solving the problem that the selected live video uploading path is single and fixed and has a low intelligence.

In order to achieve the above objectives, the present disclosure provides the following technical solutions.

In a first aspect, embodiments of the present disclosure provide a method for uploading live video, implemented by an edge server, including:

receiving a live video uploading request from a client, wherein the edge server is a node server which provides data transmission service to the client in a CDN system;

sending the uploading request to a control center, so that the control center configures uploading path information according to the uploading request, wherein the control center is configured to monitor data transmission status of all node servers in the CDN system;

receiving, from the control center, the uploading path information indicating a data transmission path made up of node servers and calculated in real time by the control center according to a preset uploading path configuration policy; and

uploading live video data of the client to a live broadcasting platform according to the uploading path information.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for uploading live video mentioned by embodiments of the present disclosure.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

receive a live video uploading request sent from the edge server;

in response to the uploading request, calculate in real time uploading path information according to a preset uploading path configuration policy, wherein the uploading path information indicates a data transmission path made up of node servers; and

send the uploading path information to the edge server.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for uploading live video in accordance with some embodiments;

FIG. 2 is a flowchart illustrating a method for uploading live video in accordance with some embodiments;

FIG. 3 is a flowchart illustrating a method for uploading live video in accordance with some embodiments;

FIG. 4 is a block diagram illustrating a structure of a device for uploading live video in accordance with some embodiments;

FIG. 5 is a block diagram illustrating a structure of another device for uploading live video in accordance with some embodiments;

FIG. 6 is a block diagram illustrating a structure of yet another device for uploading live video in accordance with some embodiments;

FIG. 7 is a block diagram illustrating a structure of yet another device for uploading live video in accordance with some embodiments;

FIG. 8 is a block diagram illustrating a system for uploading live video in accordance with some embodiments;

FIG. 9 is a block diagram illustrating a device for uploading live video in accordance with some embodiments; and

FIG. 10 is a block diagram illustrating an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

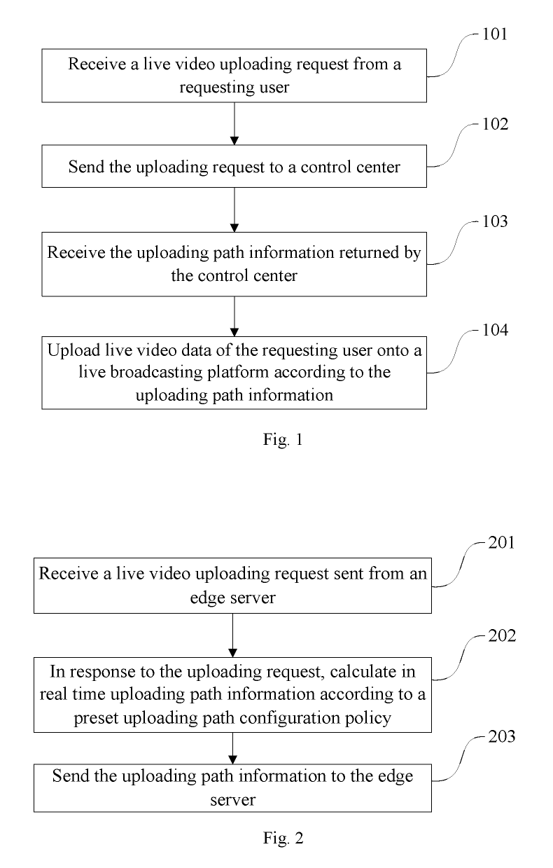

Embodiments of the present disclosure provide a method for uploading live video. As shown in FIG. 1, the method can be applied in an edge server of a CDN system. Specifically, the method can include the following steps.

In step 101, the edge server receives a live video uploading request from a requesting user.

Before uploading live video data, a requesting user needs to send an uploading request to an edge server of the CDN system. The edge server is a node server in the CDN system which has the best connective ability with the requesting user, which means, data transmission performance between the requesting user and the edge server is the best. In general CDN system, the edge server is set according to geographical areas, meaning a node server which is geographically nearby the user.

In 102, the edge server sends the uploading request to a control center.

After receiving the uploading request from the requesting user, the edge server sends the uploading request to a control center for processing. The control center configures an optimal uploading path according to the current data transmission status in the network and returns the optimal uploading path to the edge server. The control center in embodiments of the present disclosure may be a server in a relay device layer of the CDN system which is capable of monitoring data transmission status of all node servers in the CDN system and determining current operation status and load condition of respective node servers according to the data transmission status. As compared with prior technologies in which an edge server locally configures an uploading path in response to an uploading request, embodiments of the present disclosure can dynamically configure path information to bypass failed nodes in the network. Also, the edge server can use the saved process resources to perform other operations to perform other operations, for it does not need to configure an uploading path anymore, for example, receiving live video data uploaded by the requesting user or receiving uploading requests from other requesting users or anything else. Thus, the processing efficiency of edge server would be increased.

In 103, the edge server receives the uploading path information returned by the control center.

The uploading path information is indicating a data transmission path made up of node servers and calculated in real time by the control center according to a preset uploading path configuration policy. The path is made up of a plurality of node servers in the CDN system. The control center selects a transmission path having the best transmission efficiency and the shortest distance according to a preset policy.

In 104, the edge server uploads live video data of the requesting user to a live broadcasting platform according to the uploading path information.

After receiving the uploading path information returned by the control center, the edge server returns a response message to the requesting user for allowing him or her to upload the live video data. After receiving the live video data from the requesting user, the edge server sends the live video data to a live broadcasting platform according to the specific path indicated in the uploading path information.

Corresponding to the above method, embodiments of the present disclosure further provide a method for uploading live video. As shown in FIG. 2, the method is applied in a control center in a CDN system. Specifically, the method can include the following steps.

In 201, the control center receives a live video uploading request sent from an edge server.

The control center in embodiments of the present disclosure can be located in a relay device layer of the CDN system and be configured to receive video uploading requests sent from all edge servers.

In 202, in response to the uploading request, the control center calculates uploading path information in real time according to a preset uploading path configuration policy.

After receiving the live video uploading request, the control center, according to a preset uploading path configuration policy, configures a transmission path having the highest transmission speed and constituted by a plurality of node servers. The preset uploading path configuration policy is a configuration policy set by an administrator according to actual requirements of the live broadcasting platform. Based on current data transmission performance of respective node servers in the CDN system, the control center can calculate an optimal path from the edge server to the live broadcasting platform. Further, the policy can also take factors such as distance, different regions or different operators the path will pass by, and the like into account comprehensively for planning the path. The calculation of these parameters occupies a lot of process resources, therefor, the processing stress of the edge server can be reduced by stripping the path planning function out from it. And the communication states of the whole system are collected in the control center for performing the path configuration calculation from respective edge servers to the live broadcasting platform.

In 203, the control center sends the uploading path information to the edge server.

After calculating the optimal uploading path in response to the uploading request, the calculation center sends the uploading path information along with the uploading request back to the edge server.

As can be seen from the above implementations, in the method for uploading live video provided by embodiments of the present disclosure, an edge server receives a live video uploading request sent from a requesting user, and sends the request to a control center; the control center, in response to the uploading request, configures information of an uploading path for uploading live video according to the current status of the whole CDN system, and sends the uploading path information back to the edge server which received the uploading request; and finally the edge server uploads the live video data of the requesting user to a live broadcasting platform according to the uploading path information. As compared with prior method for uploading live video, the uploading path configured by using the method in embodiments of the present disclosure is a dynamic path instead of a fixed uploading path. Thus, the technical solutions in the present disclosure can configure an optimal uploading path according to the current network status, and if any policy amendments are needed for configuring uploading path, the adjustments only need to be performed in the control center, and the steps of amending path configuration files in respective edge servers can be omitted. As a result, the configuration procedure is simplified, and thereby the response efficiency of the path configuration can be improved.

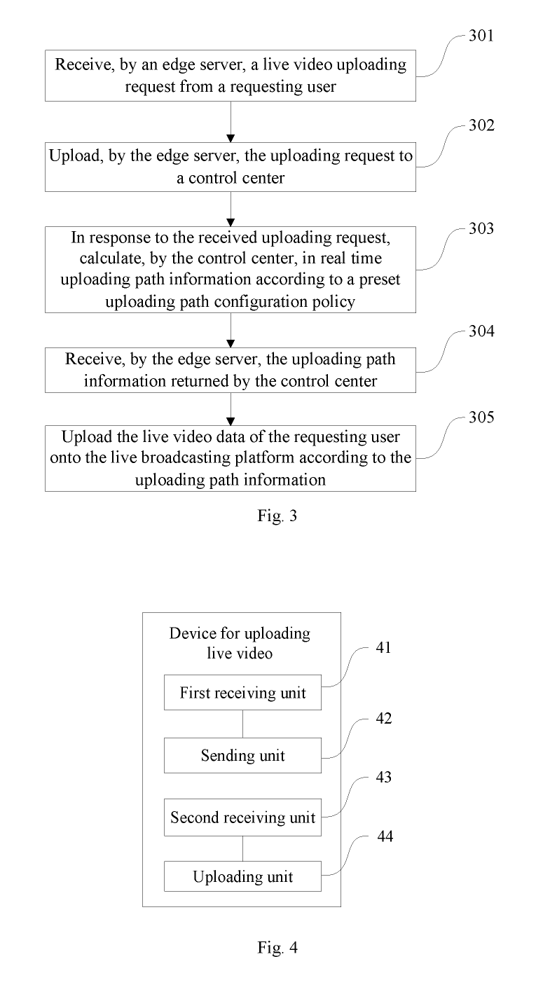

In order to describe the method for uploading live video descripted by embodiments of the present disclosure in further detail, the following description will combine the above two methods. As shown in FIG. 3, the method includes the following specific steps.

In 301, an edge server receives a live video uploading request from a requesting user.

Edge servers are distributed in the CDN system so that users in different geographical areas or served by different operators can send uploading requests to different edge servers. Edge servers can forward a part of users' requests to other edge servers for processing according to processing capacities of themselves by using load balancing system in the CDN system. This part of functions of the CDN system will not be elaborated in detail in embodiments of the present disclosure.

In 302, the edge server uploads the uploading request to a control center.

After receiving the uploading request from the requesting user, the edge server sends the uploading request to a control center. Also, before sending, the edge server can add the address information of the edge server itself into the uploading request, so that the control center can determine which edge server sends the uploading request. And the address of the edge server can also be determined as the origin address (or start address) of the uploading path. The address information of the edge server can be an IP address of the node. Uploading path request, which includes the IP address and the uploading request, will be sent to the control center for calculating an uploading path of the live video for the requesting user.

In 303, in response to the received uploading request, the control center calculates in real time uploading path information according to a preset uploading path configuration policy.

After receiving the uploading path request sent from the edge server, the control center can parses the uploading path request to obtain the address information of the edge server and the uploading request sent from the requesting user, and extracts user information of the requesting user according to the uploading request. By identifying and verifying the user information, the control center can determine whether the requesting user is an authorized user, i.e., determine whether the requesting user is a registered user. After confirming that the requesting user has the permission to upload live video, the control center performs path planning according to a preset uploading path configuration policy. Specific policy can be set by an administrator according to actual requirements, and embodiments of the present disclosure do not impose specific limitations on this. The main goal of the policy is to configure a transmission path having high data transmission speed and low cost. For example, the control center determines which nodes are available according to data transmission status of respective node servers, and then determine an uploading path using the available nodes, respective nodes belong to the same operator can be selected so as to reduce cost for data transmission.

The control center may determine the data transmission status of respective node servers in the system by sending keepalive packets to node servers in the CDN system. For example, the control center periodically sends messages to the node servers and receives response messages from them.

The path calculated according to the preset policy can be made up of node servers in the CDN system. Thus, the uploading path information can be represented by an IP address list in which IP addresses of the node servers in the uploading path are listed. For example, IP address of node servers which the uploading path passes through are listed in order, an origin node address in the node address list is the address of edge server which sends the uploading request, and an end node address is the address of a source server in a live broadcasting platform storing the live video.

Further, in order to send the server address list of the node servers in the uploading path to the edge server, the node address list can be compressed to obtain the compressed uploading path information.

In 304, the edge server receives the uploading path information returned by the control center.

After receiving the uploading path information obtained in 303, the edge server parses the uploading path information according to the specific format of the uploading path information to obtain the node address list.

While obtaining the node address list, the edge server returns a message to the requesting user who requests to upload live video to notice the requesting user a permission for uploading live video data.

In 305, the edge server uploads the live video data of the requesting user to the live broadcasting platform according to the uploading path information.

After receiving the confirmation message from the edge server, the requesting user can start to live, i.e., upload live video data. After receiving the video data uploaded by the requesting user, the edge server, according to the obtained node address list, transfers the data to a node server whose IP address is listed next to edge server in the node address list, and then the next node server sends the video data in the same way until the video data is sent to the live broadcasting platform. Then, other users over the Internet can view the video on line.

Further, embodiments of the present disclosure provide a device for uploading live video to implement the above methods. The device may be provided in a resource server in a CDN system. As shown in FIG. 4, the device can include a first receiving unit 41, a sending unit 42, a second receiving unit 43 and an upload unit 44.

The first receiving unit 41 is configured to receive, a live video uploading request from a requesting user, wherein the edge server is a node server in a CND system which provides data transmission service to the requesting user. Also, the first receiving unit 41 is further configured to receive live video data of the requesting user.

The sending unit 42 is configured to send the uploading request received by the first receiving unit 41 to a control center, so that the control center configures uploading path information according to the uploading request. The control center is configured to monitor data transmission status of all node servers in the CND system.

The second receiving unit 43 is configured to receive the uploading path information returned by the control center. The uploading path information is indicating a data transmission path made up of node servers and calculated in real time by the control center according to a preset uploading path configuration policy.

The upload unit 44 is configured to upload live video data of the requesting user to a live broadcasting platform according to the uploading path information received by the second receiving unit 43.

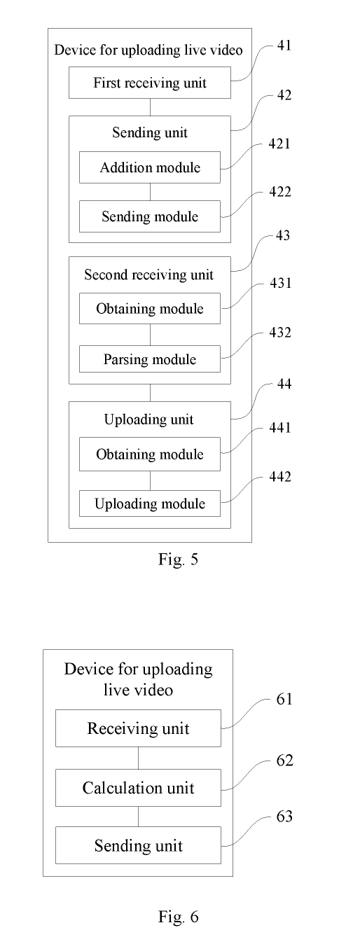

Further, as shown in FIG. 5, the sending unit 42 may include an addition module 421 and a sending module 422.

The addition module 421 is configured to add address information of the edge server into the uploading request to generate an uploading path request.

The sending module 422 is configured to send the uploading path request generated by the addition module 421 to the control center.

Further, as shown in FIG. 5, the second receiving unit 43 may include an obtaining module 431 and a parsing module 432.

The obtaining module 431 is configured to obtain the uploading path information configured by the control center according to the uploading path request.

The parsing module 432 is configured to parse the uploading path information obtained by the obtaining module 431 to obtain a node address list in which address information of respective node servers in an uploading path for uploading the live video data are listed.

Further, as shown in FIG. 5, the upload unit 44 can include an obtaining module 441 and an upload module 442.

The obtaining module 441 is configured to obtain the live video data uploaded by the requesting user.

The upload module 442 is configured to send the live video data obtained by the obtaining module to the live broadcasting platform according to the uploading path indicated by the node address list.

Further, embodiments of the present disclosure provide a device for uploading live video. The device may be provided in a control center in a CDN system. As shown in FIG. 6, the device may include a receiving unit 61, a calculation unit 62 and a sending unit 63.

The receiving unit 61 is configured to receive, a live video uploading request sent from an edge server.

The calculation unit 62 is configured to, in response to the uploading request received by the receiving unit 61, calculate in real time uploading path information indicating a data transmission path made up of node servers, according to a preset uploading path configuration policy.

The sending unit 63 is configured to send the uploading path information calculated by the calculation unit to the edge server.

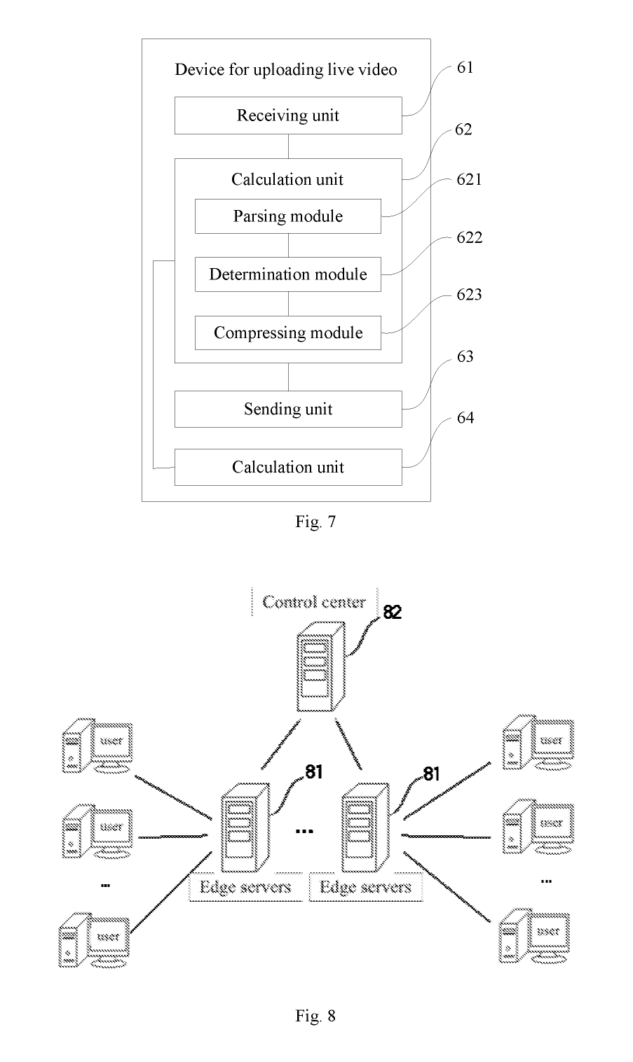

Further, as shown in FIG. 7, the calculation unit 62 may include a parsing module 621, a determination module 622 and a compressing module 623.

The parsing module 621 is configured to parse the uploading request to obtain user information of the requesting user and address information of the edge server.

The determination module 622 is configured to, according to the user information obtained by the parsing module 621 and the preset uploading path configuration policy, determine a node address list indicating an uploading path, wherein address information of respective node servers in the uploading path for uploading live video data are listed in the node address list, an origin node address in the node address list is the address of edge server, and an end node address is the address of a source server storing the live video in a live broadcasting platform.

The compressing module 623 is configured to compress the node address list determined by the determination module into the uploading path information so that the uploading path information is suitable for being sent to the edge server.

Further, as shown in FIG. 7, the device may further include a determination unit 64.

The determination unit 64 is configured to determine, data transmission status of all node servers in a CND system by keepalive packets before the uploading path information is configured according to the preset uploading path configuration policy in response to the uploading request.

Further, embodiments of the present disclosure provide a system for uploading a live video. As shown in FIG. 8, the system includes an edge server 81 which includes a device for uploading live video as mentioned above and a control center 82 which includes a device for uploading live video as mentioned above.

The edge server 81 receives a live video uploading request sent from a requesting user, sends the uploading request to the control center 82, and uploads live video data of the requesting user to a live broadcasting platform according to the uploading path information returned by the control center.

The control center 82 receives a live video uploading request sent from the edge server 81, calculates in real time uploading path information according to a preset uploading path configuration policy in response to the uploading request, and sends the obtained uploading path information to the edge server.

In view of the above, in the method, device and system for uploading live video provided by embodiments of the present disclosure, an edge server receives a live video uploading request sent from a requesting user, and sends the request to a control center; the control center, in response to the uploading request, configures information of an uploading path for uploading live video according to the current status of the whole CDN system, and sends the uploading path information back to the edge server which received the uploading request; and finally the edge server uploads the live video data of the requesting user to a live broadcasting platform according to the uploading path information. As compared with prior method for uploading live video, the uploading path configured by using the method in embodiments of the present disclosure is a dynamic path instead of a fixed one. Thus, the technical solutions in the present disclosure can configure an optimal uploading path according to the current network status, and if any policy amendments are needed for configuring uploading path, the adjustments only need to be performed in the control center, and the steps of amending path configuration files in respective edge servers can be omitted. As a result, the configuration procedure is simplified, and thereby the response efficiency of the path configuration can be improved.

It shall be noted that the functions of respective units or modules in the above devices for uploading live video according to embodiments of the present disclosure can be realized by hardware processors.

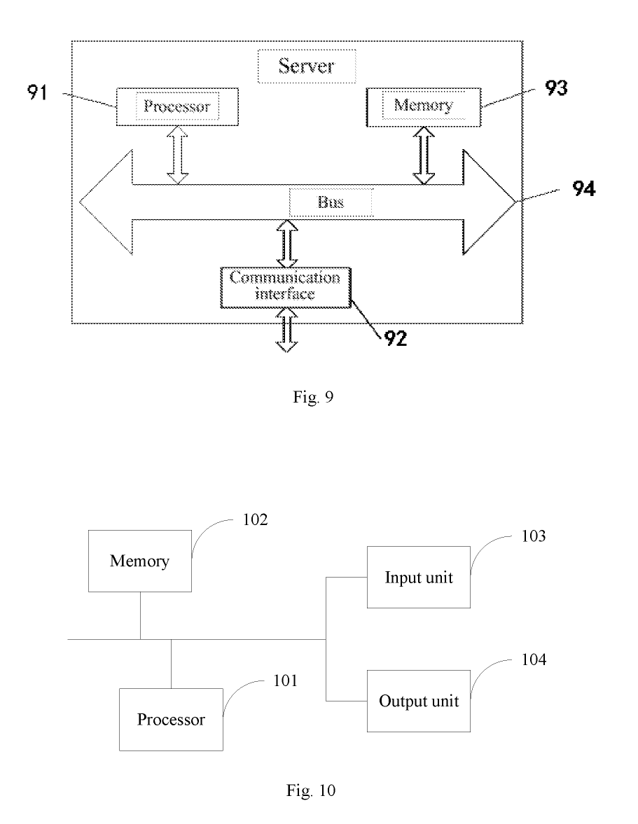

As an example, FIG. 9 is a block diagram showing a device for uploading live video according to another embodiment of the present disclosure. In the embodiment, the device for uploading live video is provided in a physical server which may include a processor 91, a communication interface 92, a memory 93 and a bus 94. The processor 91, the communication interface 92 and the memory 93 communicate with each other via the bus 94. The communication interface 92 may be used for information transmission between the server and a client. The processor 91 calls on logic instructions in the memory 93 to perform the following method: the edge server receiving a live video uploading request sent from a requesting user, wherein the edge server is a node server in a CND system which provides data transmission service to the requesting user; sending the request to a control center so that the control center configures uploading path information according to the uploading request, wherein the control center is configured to monitor data transmission status of all node servers in the CDN system; receiving the uploading path information returned by the control center, wherein the uploading path information is indicating a data transmission path made up of node servers and calculated in real time by the control center according to a preset uploading path configuration policy; and uploading live video data of the requesting user to a live broadcasting platform according to the uploading path information.

In addition, the logic instructions in the memory 93 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for uploading live video mentioned by embodiments of the present disclosure.

FIG. 10 is a block diagram of an electronic device which is configured to perform the methods for uploading live video according to an embodiment of the present disclosure. As shown in FIG. 10, the device includes: one or more processors 101 and memory 102. A processor 101 is showed in FIG. 10 for an example.

Device which is configured to perform the methods for uploading live video can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for uploading live video mentioned by embodiments of the present disclosure (such as shown in FIG. 4, first receiving unit 41, sending unit 42, second receiving unit 43 and uploading unit 44). Processor 101 performs kinds of functions and uploading live video of the electronic device by executing non-transitory software program, instructions and modules which are stored in memory 102, thereby realizes the methods for uploading live video mentioned by embodiments of the present disclosure.

Memory 102 can include program storage area and data storage area, thereby the operating system and applications required by at least one function can be stored in program storage area and data created by using the device for uploading live video can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for uploading live video by networks. The examples of said networks are including but not limited to Internet, Intranet, LAN, mobile Internet and their combinations.

Input unit 103 can be used to receive inputted number, character information and key signals causing user configures and function controls of the device for uploading live video. Output unit 104 can include a display screen or a display device.

The said module or modules are stored in memory 102 and perform the methods for uploading live video when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for uploading live video, implemented by an edge server, comprising:
receiving a live video uploading request from a client, wherein the edge server is a node server which provides data transmission service to the client in a content delivery network (CDN) system;
sending the uploading request to a control center, so that the control center configures uploading path information according to the uploading request, wherein the control center is configured to monitor data transmission status of all node servers in the CDN system;
receiving, from the control center, the uploading path information indicating a data transmission path made up of node servers and calculated in real time by the control center according to a preset uploading path configuration policy; and
uploading live video data of the client to a live broadcasting platform according to the uploading path information.

2. The method according to claim 1, wherein sending the uploading request to the control center, comprises:
adding address information of the edge server into the uploading request to generate an uploading path request; and
sending the uploading path request to the control center.

3. The method according to claim 2, wherein receiving the uploading path information from the control center, comprises:
obtaining the uploading path information configured by the control center according to the uploading path request; and
parsing the uploading path information to obtain a node address list in which address information of respective node servers in an uploading path for uploading the live video data are listed.

4. The method according to claim 1, wherein receiving the uploading path information from the control center, comprises:
obtaining the uploading path information configured by the control center according to the uploading path request; and
parsing the uploading path information to obtain a node address list in which address information of respective node servers in an uploading path for uploading the live video data are listed.

5. The method according to claim 4, wherein uploading the live video data of the client to the live broadcasting platform according to the uploading path information, comprises:
obtaining the live video data uploaded by the client; and
sending the live video data to the live broadcasting platform according to the uploading path indicated by the node address list.

6. The method according to claim 3, wherein uploading the live video data of the client to the live broadcasting platform according to the uploading path information, comprises:
obtaining the live video data uploaded by the client; and
sending the live video data to the live broadcasting platform according to the uploading path indicated by the node address list.

7. An electronic device, comprising:
at least one processor; and
a memory communicably connected with the at least one processor for storing instructions executable by the at least one processor, wherein execution of the instructions by the at least one processor causes the at least one processor to:
receive a live video uploading request from a client, wherein the edge server is a node server which provides data transmission service to the client in a CDN system;
send the uploading request to a control center, so that the control center configures uploading path information according to the uploading request, wherein the control center is configured to monitor data transmission status of all node servers in the CDN system;
receive, from the control center, the uploading path information indicating a data transmission path made up of node servers and calculated in real time by the control center according to a preset uploading path configuration policy; and
upload live video data of the client to a live broadcasting platform according to the uploading path information.

8. The electronic device according to claim 7, wherein the instructions are executed to cause the at least one processor to:
add address information of the edge server into the uploading request to generate an uploading path request; and
send the uploading path request to the control center.

9. The electronic device according to claim 8, wherein the instructions are executed to cause the at least one processor to:
obtain the uploading path information configured by the control center according to the uploading path request; and
parse the uploading path information to obtain a node address list in which address information of respective node servers in an uploading path for uploading the live video data are listed.

10. The electronic device according to claim 7, wherein the instructions are executed to cause the at least one processor to:
obtain the uploading path information configured by the control center according to the uploading path request; and
parse the uploading path information to obtain a node address list in which address information of respective node servers in an uploading path for uploading the live video data are listed.

11. The electronic device according to claim 10, wherein the instructions are executed to cause the at least one processor to:
obtain the live video data uploaded by the client; and
send the live video data to the live broadcasting platform according to the uploading path indicated by the node address list.

12. The electronic device according to claim 9, wherein the instructions are executed to cause the at least one processor to:
obtain the live video data uploaded by the client; and
send the live video data to the live broadcasting platform according to the uploading path indicated by the node address list.

13. An electronic device, comprising:
at least one processor; and
a memory communicably connected with the at least one processor for storing instructions executable by the at least one processor, wherein execution of the instructions by the at least one processor causes the at least one processor to:
receive a live video uploading request sent from the edge server;
in response to the uploading request, calculate in real time uploading path information according to a preset uploading path configuration policy, wherein the uploading path information indicates a data transmission path made up of node servers; and
send the uploading path information to the edge server.

14. The electronic device according to claim 13, wherein the instructions are executed to cause the at least one processor to:
parse the uploading request to obtain user information of the client and address information of the edge server;
according to the user information and the preset uploading path configuration policy, determine a node address list indicating an uploading path, wherein address information of respective node servers in the uploading path for uploading live video data are listed in the node address list, an origin node address in the node address list is the address of edge server, and an end node address is the address of a source server storing the live video in a live broadcasting platform; and
compress the node address list into the uploading path information so that the uploading path information is suitable for being sent to the edge server.

15. The electronic device according to claim 13, wherein the instructions are executed to cause the at least one processor to:
before the uploading path information is configured according to the preset uploading path configuration policy in response to the uploading request, determine data transmission status of all node servers in a CDN system by keepalive packets.
